(19) United States
(12) Patent Application Publication
(10) Pub. No.: US 2009/0072786 A1
(43) Pub. Date: Mar. 19, 2009

(54) Cradle for differently sized portable electronic devices

(75) Inventors: Meng-Nan Lin, Taipei Hsien (TW); Shih-Hong Chen, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/222,400

(22) Filed: Aug. 8, 2008

(30) Foreign Application Priority Data
Sep. 10, 2007 (TW) 096215191

(51) Int. Cl. A41F 1/00; H05K 5/00; H01R 13/627; H02J 7/00

(52) U.S. Cl. 320/114; 24/499; 439/366

(57) ABSTRACT

A cradle for containing a portable electronic device of the present invention has a main body and a clip. The main body is used for enabling the bottom of the portable electronic device to lean on the main body. The clip has a rotating member and a pressing member. The rotating member is pivoted on the main body, the pressing member is detachably connected to the rotating member, and the pressing member presses against the top portion of the portable electronic device.

### BACKGROUND OF THE INVENTION

1. Field of the Invention

The present invention relates to a cradle for electronic devices, and more particularly, to a cradle for differently sized portable electronic devices.

2. Description of the Related Art

Portable electronic devices such as hand-held videogames, mobile phones, radios, GPSs, etc. are common consumer electronic devices. When a user wants to carry a portable electronic device with them, or to charge the portable electronic device, they need to use a cradle to secure the electronic device.

In the prior art technology of cradles for portable electronic devices, Taiwan patent No. M282329 discloses a cradle for the hand-held videogame. However, this cradle has a fixed size and so it is useable only specifically for the hand-held videogame, which limits the usability of this cradle.

Taiwan patent No. 487259 discloses an adjustable cradle for mobile phones, which can be adjusted to fit variously sized mobile phones. This cradle uses a small screw and a movable block, the small screw being used to move the block to provide different cradle sizes for differently sized phones. However, this cradle requires many other parts to work with the screw so the structure of the entire cradle is complicated, more expensive for manufacturing and difficult to operate.

Therefore, it is desirable to provide a cradle for differently sized portable electronic devices to mitigate and obviate the aforementioned problems.

### SUMMARY OF THE INVENTION

An objective of the present invention is to provide a cradle for differently sized portable electronic devices.

In order to achieve the above mentioned objective, a cradle of the present invention comprises a main body and a clip. The main body is used for enabling the bottom of the portable electronic device to lean on the main body. The clip has a rotating member and a pressing member. The rotating member is pivoted on the main body, the pressing member is detachably connected to the rotating member, and the pressing member presses against the top portion of the portable electronic device.

According to an embodiment of the present invention, the rotating member comprises at least one indentation, and the pressing member comprises at least one protrusion, and the protrusion can be attached to the indentation.

According to another embodiment of the present invention, the rotating member comprises at least one first fastening member, the pressing member comprising at least one second fastening member, and the first fastening member is attached to the second fastening member.

According to another embodiment of the present invention, the rotating member comprises an elongated slot, the pressing member comprises an elongated protrusion, and the elongated protrusion is capable of being inserted into the elongated slot.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a cradle for electronic devices according to the present invention.

FIG. 2 is a perspective view of a cradle for electronic devices according to the present invention.

FIG. 3 is a perspective view of a cradle for electronic devices while a pressing member is flipped up according to the present invention.

FIG. 4 is a perspective view of a portable electronic device placed in a cradle for electronic devices according to the present invention.

FIG. 5 is a schematic drawing of a pressing member of a cradle for electronic devices according to the present invention.

FIG. 6 is a perspective view of a cradle for electronic devices holding a portable electronic device according to the present invention.

FIG. 7 is a schematic drawing of a cradle for electronic devices having a larger pressing member for a larger sized portable electronic device according to the present invention.

FIG. 8 is a perspective view of a cradle for electronic devices holding a larger sized portable electronic device according to the present invention.

FIG. 9 is a schematic drawing of a cradle for electronic devices having a smaller pressing member for smaller sized portable electronic device according to the present invention.

FIG. 10 is a perspective view of a cradle for electronic devices holding a smaller sized portable electronic device according to the present invention.

FIG. 11 and FIG. 12 are exploded views of different embodiments of a rotating member and a pressing member according to the present invention.

FIG. 13 and FIG. 14 are perspective views of a connecting unit of a cradle for electronic devices having a different structure according to the present invention.

FIG. 15 is a back side view of a cradle for electronic devices according to the present invention.

### DETAILED DESCRIPTION OF THE PREFERRED EMBODIMENT

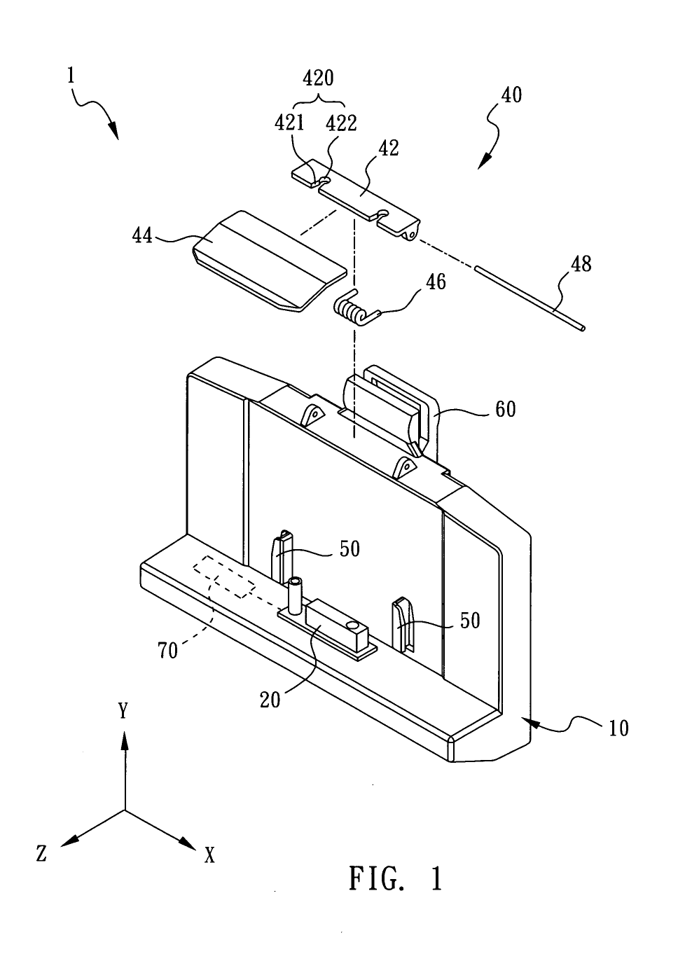

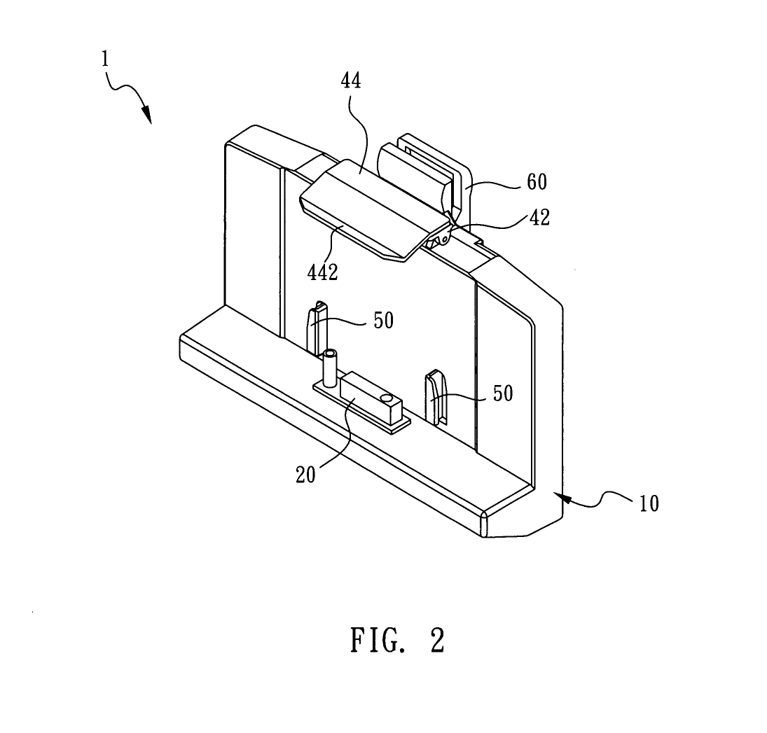

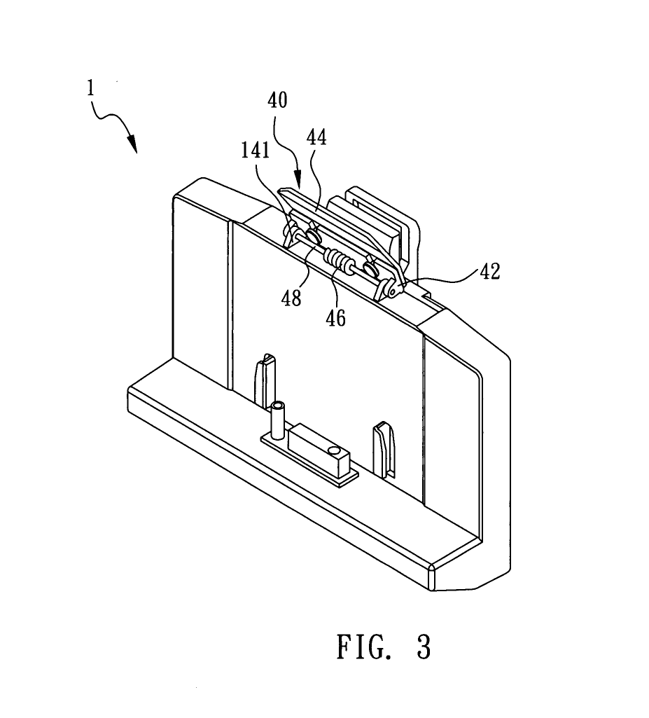

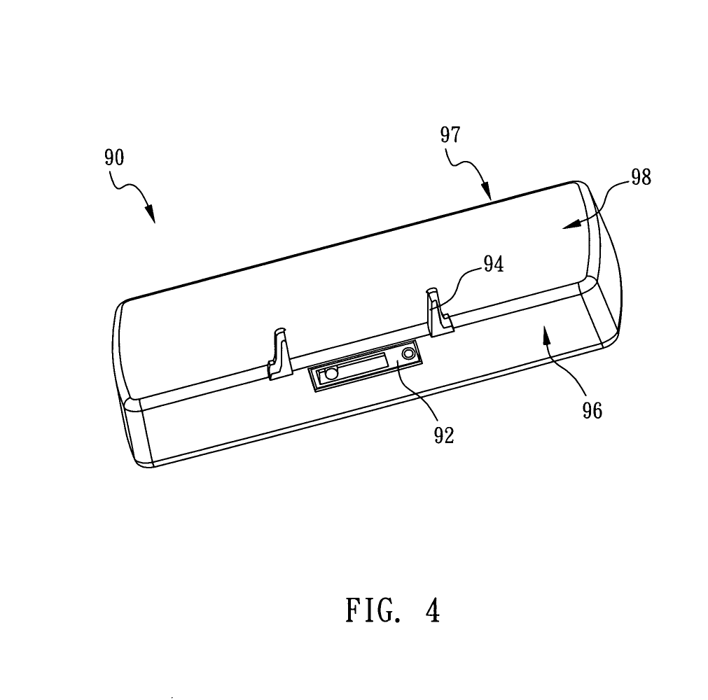

Please refer to FIG. 1 to FIG. 4. FIG. 1 is an exploded view of a cradle for electronic devices according to the present invention. FIG. 2 is a perspective view of the cradle for electronic devices according to the present invention. FIG. 3 is a perspective view of the cradle for electronic devices while a pressing member is flipped up according to the present invention. FIG. 4 is a perspective view of a portable electronic device being placed in the cradle for electronic devices according to the present invention. A cradle 1 is used for holding a portable electronic device 90 (as shown in FIG. 4), the portable electronic device 90 has a bottom portion 96 and a corresponding top portion 97. For example, the portable electronic device 90 can be a satellite radio, a GPS, a hand-held videogame, a mobile phone, and other such small sized portable electronic devices.

The cradle 1 comprises a main body 10, a connecting unit 20 and a clip 40. The main body 10 permits the bottom 96 of the portable electronic device 90 to lean against to the main body 10. The clip 40 comprises a rotating member 42 and a pressing member 44. The rotating member 42 is pivoted onto the main body 10, and the pressing member 44 is detachably connected to the rotating member 42. The pressing member 44 presses against the top portion 97 of the portable electronic device 90. Consequently, the clip 40 provides perpendicular positioning for the portable electronic device 90 (along the direction of the Y axis, as shown in FIG. 1), and so the portable electronic device 90 remains on the main body 10 without moving.

The shape and location of the connecting unit 20 are designed to match the portable electronic device 90. In this embodiment, the connecting unit 20 protrudes from the main body 10 (as shown in FIG. 1), and the electrical connector 92 of the portable electronic device 90 is recessed (as shown in FIG. 4). When the connecting unit 20 is connected to the portable electronic device 90, the connecting unit 20 provides horizontal positioning for the portable electronic device 90 (along the direction of the X axis, as shown in FIG. 1).

In this embodiment, the cradle 1 comprises a battery 70. The battery 70 is electrically connected to the connecting unit 20, and the connecting unit 20 is electrically connected to the portable electronic device 90. When the electrical connector 92 of the portable electronic device 90 is attached to the main body 10 via the connecting unit 20, the cradle 1 can charge the portable electronic device 90 using the battery 70 via the connecting unit 20. As a result, the connecting unit 20 provides both positioning and electrical connectivity.

Please refer to FIG. 3. In this embodiment, the clip 40 comprises a rotating member 42, a pressing member 44, a rotating shaft 48 and an elastic member 46. A top portion of the main body 10 has a shaft support 141, and by passing the rotating shaft 48 through the shaft support 141 and the rotating member 42, the rotating member 42 is pivoted on the main body 10. The elastic member 46 is a torsion spring that is slipped onto the rotating shaft 48, and two ends of the torsion spring respectively press against the main body 10 and the rotating member 42. To ensure the cradle 1 is suitable for variously sized portable electronic devices 90, the pressing member 44 is detachable from the rotating member 42 and can be replaced in different sizes.

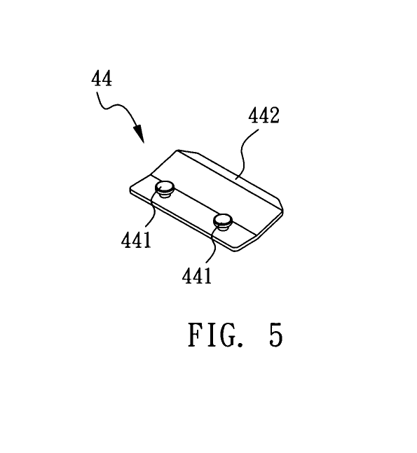

One end of the pressing member 44 is connected to the rotating member 42, and another end of the pressing member 44 presses against the portable electronic device 90. A compressive force is provided by torsion from the elastic member 46 so that the elastic member 46 provides a pressing face 442 of the pressing member 44 that has a downward force (along the direction of the Y axis shown in FIG. 1). In this embodiment, the rotating member 42 comprises two indentations 420 (as shown in FIG. 1). Each indentation 420 has a narrow portion 421 and a containment space 422, and the pressing member 44 has two protrusions 441 (as shown in FIG. 5). The protrusion 441 is engaged through the narrow portion 421 of the indentation 420 and held in the containment space 422 so that the pressing member 44 is attached to the rotating member 42.

The pressing member 44 is designed to match the height of the portable electronic device 90, so that when the portable electronic device 90 is placed in the cradle 1, the pressing face 442 of the pressing member 44 contacts the portable electronic device 90, and the elastic member 46 continuously provides the proper holding strength via the pressing face 442 for the portable electronic device 90.

For different sizes (heights for example) of portable electronic devices 90, the pressing member 44 can be swapped for differently sized and shaped pressing members. As a result, the cradle 1 of the present invention is suitable for differently sized portable electronic devices 90.

A side face 98 of the portable electronic device 90 has a fastening slot 94 (as shown in FIG. 4) for improving horizontal positioning of the portable electronic device 90. The main body 10 comprises a fastening hook 50 corresponding to the fastening slot 94 of the portable electronic device 90. When the fastening slot 94 of the portable electronic device 90 is attached to the fastening hook 50, the portable electronic device 90 is unable to move horizontally. Alternatively, if the portable electronic device 90 has no fastening slot 94, the cradle 1 has no need for having the fastening hook 50.

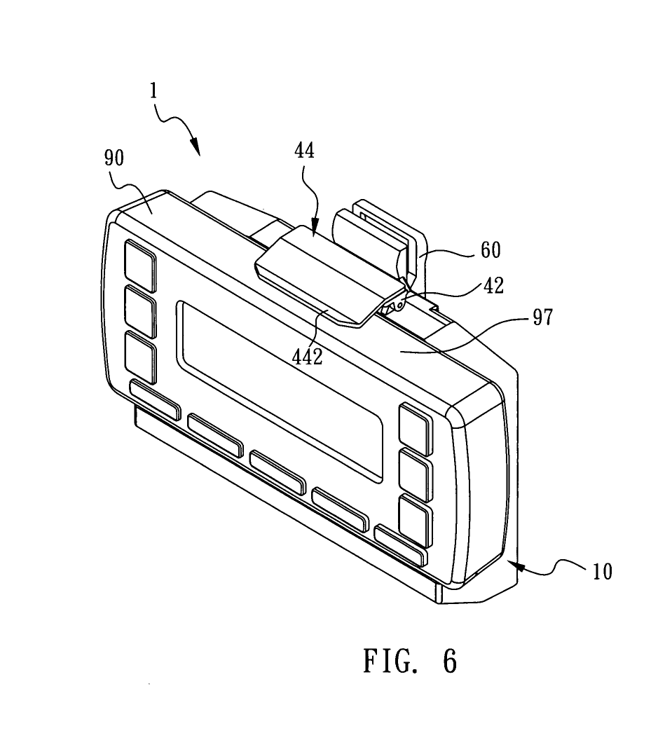

The following description provides an explanation for how to place the portable electronic device 90 in the cradle 1. First, a properly sized pressing member (the pressing member 44 is used by way of example here) is selected. The rotating member 42 is inserted (as shown in FIG. 2), slightly flipping up the pressing member 44 (as shown in FIG. 3) to attach the fastening slot 94 of the portable electronic device 90 to the fastening hook 50 of the cradle 1. The electrical connector 92 of the portable electronic device 90 is also placed in the connecting unit 20 of the cradle 1. Finally, the pressing face 442 is pressed onto the top portion 97 of the portable electronic device 90 to complete the assembly (as shown in FIG. 6).

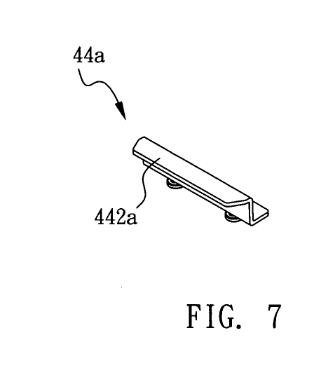

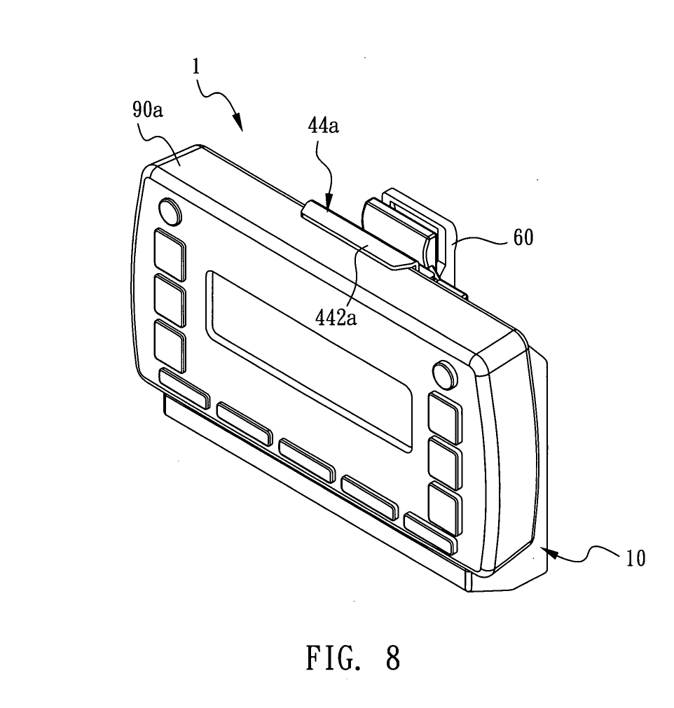

Please refer to both FIG. 7 and FIG. 8. FIG. 7 is a schematic drawing of the cradle for electronic devices having a larger pressing member for a larger sized portable electronic device according to the present invention. FIG. 8 is a perspective view of the cradle for electronic devices holding a larger sized portable electronic device according to the present invention. As shown in FIG. 8, the portable electronic device 90a has a height greater than the portable electronic device 90. To fit the portable electronic device 90a in the cradle 1, the pressing face 442a of the pressing member 44a is extended upward, so that the distance between the pressing face 442a and the bottom of the main body 10 of the cradle 1 is increased, and the cradle 1 is thus capable of holding the larger portable electronic device 90a.

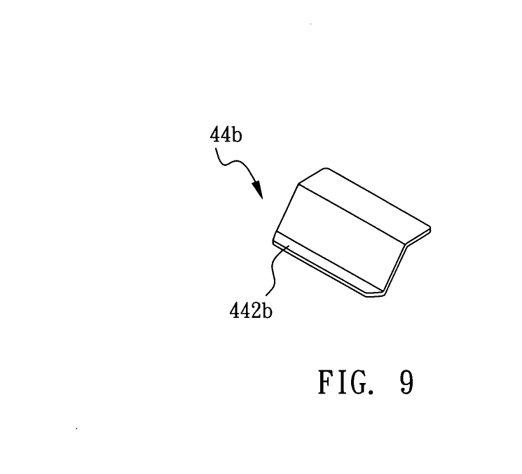

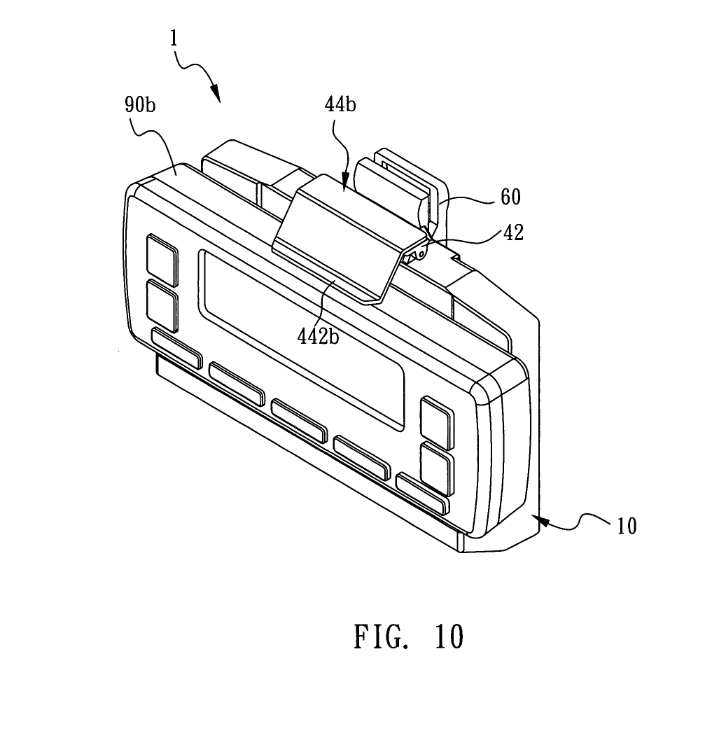

Please refer to both FIG. 9 and FIG. 10. FIG. 9 is a schematic drawing of the cradle for electronic devices having a smaller pressing member for a smaller sized portable electronic device. FIG. 10 is a perspective view of the cradle for electronic devices holding the smaller sized portable electronic device. As shown in FIG. 10, the portable electronic device 90b has a lower height than the portable electronic device 90. In order to fit the portable electronic device 90b in the cradle 1, the pressing face 442a of the pressing member 44a is extended downward so that the distance between the pressing face 442a and bottom of the main body 10 of the cradle 1 is reduced, and the cradle 1 is thus able to hold the smaller portable electronic device 90b.

Accordingly, when the cradle 1 holds a portable electronic device, for differently sized portable electronic devices, a proper pressing member 44, 44a or 44b may be selected. Moreover, it will be understood that various numbers and shapes of pressing members may be used.

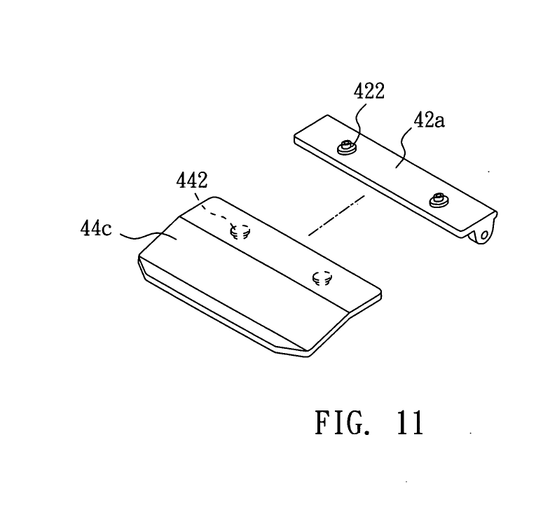

The structure of the clip 40 can be different from that of the above-discussed design. For example, the pressing member and the rotating member can be connected together by way of clipping or insertion. FIG. 11 is an exploded view of a different embodiment of a rotating member and pressing member according to the present invention. A rotating member 42a comprises two first fastening members 422, the pressing member 44c comprises two second fastening members 442, and the first fastening members 422 are designed to match the second fastening members 442, while the first fastening member 422 is fastened to the second fastening member 442 to secure the pressing member 44c to the rotating member 42a. For example, the first fastening member 422 is a male member, and the second fastening member 442 is a corresponding female member.

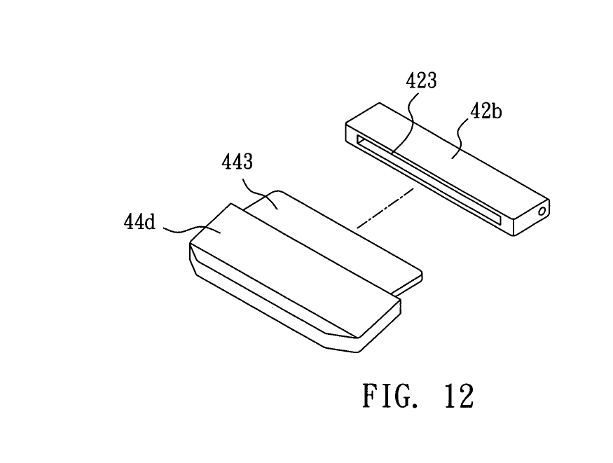

Please refer to FIG. 12. FIG. 12 is an exploded view of another embodiment for a rotating member and pressing member according to the present invention. As shown in FIG. 12, the rotating member 42b comprises an elongated slot 423, the pressing member 44d comprises an elongated protrusion 443, and the elongated slot 423 is designed to correspond to the elongated protrusion 443. By sliding the elongated protrusion 443 into the elongated slot 423, the pressing member 44d is secured to the rotating member 42b.

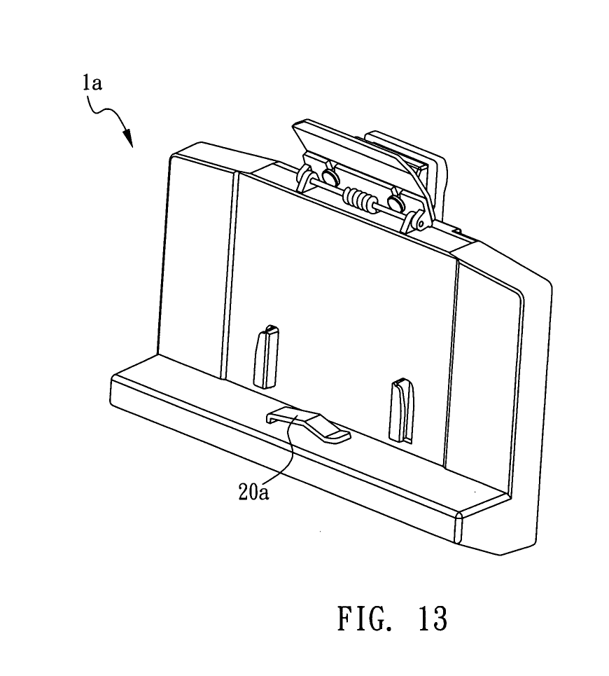

The connecting unit of the cradle can vary from the above-discussed designs. Please refer to FIG. 13. In this embodiment, the connecting unit 20a of a cradle 1a is a spring sheet made of a conductive material. Therefore, the connecting unit 20a is used only for providing electrical connection to the portable electronic device and not for preventing the portable electronic device from moving horizontally.

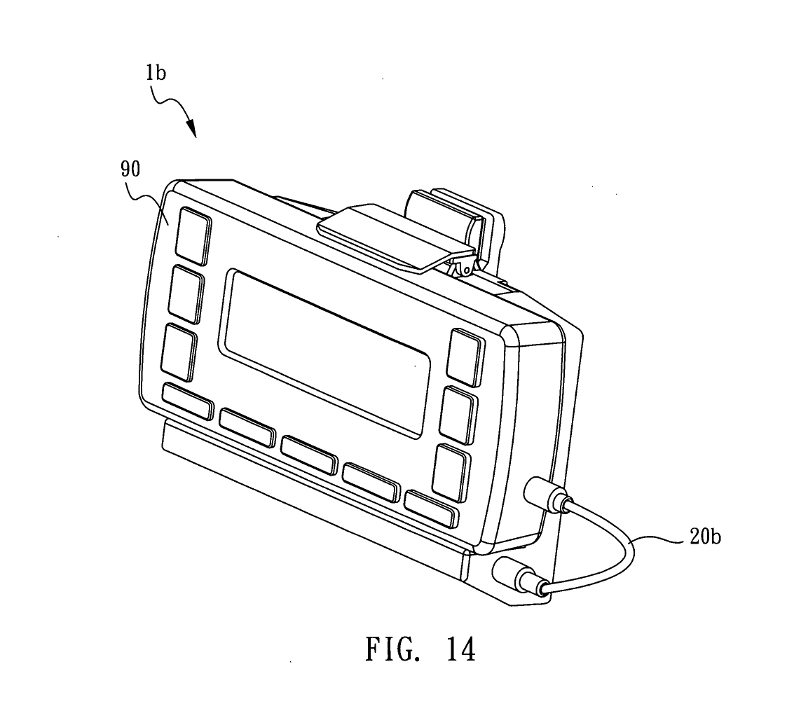

Please refer to FIG. 14. In this embodiment, the connecting unit 20b of a cradle 1b is a power supply cable. The connecting unit 20b is used only for providing an electrical connection to the portable electronic device. When the cradle 1b is not used for charging the portable electronic device, the connecting unit 20b can be removed.

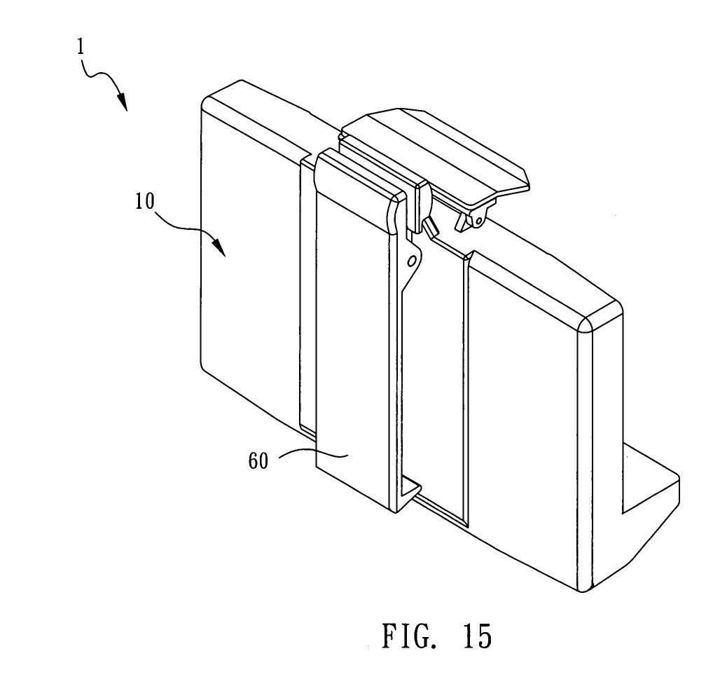

Please refer to FIG. 15. FIG. 15 is a back side view of the cradle for electronic devices according to the present invention. The cradle 1 comprises a back clip 60. The back clip 60 is attached to the back of the main body 10, and the back clip 60 can be clipped onto a belt so that the user can carry the portable electronic device with them.

Although the present invention has been explained in relation to its preferred embodiment, it is to be understood that many other possible modifications and variations can be made without departing from the spirit and scope of the invention as hereinafter claimed.

What is claimed is:

1. A cradle for containing a portable electronic device, the portable electronic device having a bottom portion and a top portion, the cradle comprising:
a main body for enabling the bottom of the portable electronic device to lean on the main body; and
a clip having a rotating member and a pressing member, the rotating member pivoted on the main body, the pressing member detachably connected to the rotating member, wherein the pressing member presses against the top portion of the portable electronic device.

2. The cradle as claimed in claim 1 further comprising a battery and a protruding connecting unit, the portable electronic device further comprising a recessed electrical connector; wherein the battery is electrically connected to the connecting unit, the connecting unit is electrically connected to the portable electronic device, and the connecting unit prevents the portable electronic device from moving horizontally.

3. The cradle as claimed in claim 2, wherein the main body further comprises at least one hook, the portable electronic device further comprises at least one slot, and the at least one hook can be attached to the at least one slot to prevent the portable electronic device from moving horizontally.

4. The cradle as claimed in claim 1, wherein the main body further comprises at least one hook, the portable electronic device further comprises at least one slot, and the at least one hook can be attached to the at least one slot to prevent the portable electronic device from moving horizontally.

5. The cradle as claimed in claim 4 further comprising a battery and a connecting unit, the battery electrically connected to the connecting unit, and the connecting unit capable of being electrically connected to the portable electronic device.

6. The cradle as claimed in claim 5, wherein the connecting unit is a spring sheet.

7. The cradle as claimed in claim 5, wherein the connecting unit is a power line.

8. The cradle as claimed in claim 1, wherein the rotating member comprises at least one indentation, the pressing member comprising at least one protrusion, and the protrusion can be attached to the indentation.

9. The cradle as claimed in claim 1, wherein the rotating member comprises at least one first fastening member, the pressing member comprising at least one second fastening member, and the first fastening member is attached to the second fastening member.

10. The cradle as claimed in claim 1, wherein the rotating member comprises an elongated slot, the pressing member comprising an elongated protrusion, and the elongated protrusion is capable of being inserted into the elongated slot.

11. The cradle as claimed in claim 1, wherein the clip further comprises a rotating shaft, and the rotating member is pivoted onto the main body via the rotating shaft.

12. The cradle as claimed in claim 1, wherein the clip further comprises an elastic member, and the pressing member presses against to the portable electronic device via the elastic member.

13. The cradle as claimed in claim 1 further comprising a back clip that is attached onto the main body.
